(19) United States
(12) Patent Application Publication
(10) Pub. No.: US 2023/0147513 A1
(43) Pub. Date: May 11, 2023

(54) SNPN-RAN ENTITY, DISTRIBUTION SYSTEM, DISTRIBUTION METHOD, AND NON-TEMPORARY COMPUTER READABLE MEDIUM

(71) Applicant: NEC Corporation, Minato-ku, Tokyo (JP)

(72) Inventor: Toshiyuki TAMURA, Tokyo (JP)

(73) Assignee: NEC Corporation, Minato-ku, Tokyo (JP)

(21) Appl. No.: 17/918,415

(22) PCT Filed: Apr. 22, 2021
(86) PCT No.: PCT/JP2021/016282

§ 371 Date: Oct. 12, 2022

(30) Foreign Application Priority Data
Apr. 22, 2020 (JP) 2020076125

(51) Int. Cl. H04W 4/90; H04W 48/10

(52) U.S. Cl. CPC H04W 4/90; H04W 48/10

(57) ABSTRACT

An object of the present disclosure is to provide an SNPN-RAN entity capable of distributing emergency information to a communication terminal using SNPN. An SNPN-RAN entity (10) according to the present disclosure includes: a reception unit (11) configured to receive, from a base station deployed in a network operated by a communication carrier, emergency information transmitted by using a first frequency used by the communication carrier; and a transmission unit (12) configured to transmit, by using a second frequency used in a Stand-Alone Non-Public Network (SNPN), the emergency information to a communication terminal registered in the SNPN.

### TECHNICAL FIELD

The present disclosure relates to a Stand-alone Non-Public Networks (SNPN)-Radio Access Network (RAN) entity, a distribution system, a distribution method, and a program.

### BACKGROUND ART

In 3rd generation partnership project (3GPP), as a radio system for achieving higher-speed communication than long term evolution (LTE), a standard specification of a radio system called 5th Generation (5G) has been established. A communication system that achieves 5G (hereinafter, referred to as a 5G communication system) has a base station supporting 5G (hereinafter, referred to as a 5G base station) as a radio system, and a core network accommodating the base station supporting 5G (hereinafter, referred to as a 5G core network). In the 5G communication system, there are a form in which a communication carrier operates the 5G communication system in order to provide a service for a wide range of general users, and a form in which a provider or an enterprise being different from the communication carrier directly operates the 5G communication system without intervention of the communication carrier. In the 3GPP, stand-alone non-public networks (SNPN) are defined as a 5G communication system directly operated by an enterprise. Apart from a 5G base station and a 5G core network being operated by a communication carrier, the SNPN have a 5G base station and a 5G core network being operated directly by an enterprise. Location information of a communication terminal using the SNPN, subscriber information, and the like are registered in the 5G core network directly operated by the enterprise. Meanwhile, Non Patent Literature 1 discloses a technique for performing interworking with a 5G communication system provided by a communication carrier even in a case of the SNPN.

Herein, in the 3GPP, a specification of a public warning system (PWS) for distributing information in an emergency such as a disaster is defined. The PWS is used as an earthquake and tsunami warning system (ETWS) for distributing emergency information in Japan. Non Patent Literature 2 defines that emergency information to be distributed in the ETWS is also distributed to a communication terminal for which location information, subscriber information, and the like are not managed in a 5G communication system operated by a communication carrier. Therefore, even in a communication terminal in which location information, subscriber information, and the like are registered only in a 5G core network directly operated by an enterprise, it is necessary to be able to receive information distributed from the ETWS.

### CITATION LIST

### Non Patent Literature

Non Patent Literature 1: 3GPP TS23.501 V16.3.0 (2019-12)

Non Patent Literature 2: 3GPP TS25.304 V15.0.0 (2018-06)

### SUMMARY OF INVENTION

### Technical Problem

However, Non Patent Literature 2 does not explicitly describe a cooperation procedure between the 5G communication system operated by the communication carrier and the SNPN. Therefore, a procedure of distributing emergency information distributed via the 5G communication system operated by the communication carrier to the SNPN is not clear. As a result, there is a problem that a communication terminal using the SNPN cannot receive the emergency information.

An object of the present disclosure is to provide an SNPN-RAN entity, a distribution system, a distribution method, and a program that are capable of distributing emergency information to a communication terminal using SNPN.

### Solution to Problem

An SNPN-RAN entity according to a first example aspect of the present disclosure includes: a reception unit configured to receive, from a base station deployed in a network operated by a communication carrier, emergency information transmitted by using a first frequency used by the communication carrier; and a transmission unit configured to transmit, by using a second frequency used in a Stand-Alone Non-Public Network (SNPN), the emergency information to a communication terminal registered in the SNPN.

A distribution system according to a second example aspect of the present disclosure includes: a reception apparatus configured to receive, from a base station deployed in a network operated by a communication carrier, emergency information transmitted by using a first frequency used by the communication carrier; and an SNPN-RAN entity configured to transmit, by using a second frequency used in a Stand-Alone Non-Public Network (SNPN), the emergency information received from the reception apparatus to a communication terminal registered in the SNPN.

A distribution method according to a third example aspect of the present disclosure includes: receiving, from a base station deployed in a network operated by a communication carrier, emergency information transmitted by using a first frequency used by the communication carrier; and transmitting, by using a second frequency used in a Stand-Alone Non-Public Network (SNPN), the emergency information to a communication terminal registered in the SNPN.

A program according to a fourth example aspect of the present disclosure causes a computer to: receive, from a base station deployed in a network operated by a communication carrier, emergency information transmitted by using a first frequency used by the communication carrier; and transmit, by using a second frequency used in a Stand-Alone Non-Public Network (SNPN), the emergency information to a communication terminal registered in the SNPN.

### Advantageous Effects of Invention

According to the present disclosure, it is possible to provide an SNPN-RAN entity, a distribution system, a distribution method, and a program that are capable of distributing emergency information to a communication terminal using SNPN.

### BRIEF DESCRIPTION OF DRAWINGS

FIG. 1 is a configuration diagram of an SNPN-RAN entity according to a first example embodiment;

FIG. 2 is a configuration diagram of a communication system according to a second example embodiment;

FIG. 3 is a diagram of an SNPN-RAN entity according to the second example embodiment;

FIG. 4 is a diagram showing a flow of processes for transmitting emergency information according to the second example embodiment;

FIG. 5 is a diagram showing a flow of processes for transmitting emergency information in the SNPN-RAN entity according to the second example embodiment;

FIG. 6 is a diagram showing a flow of processes for transmitting emergency information according to a third example embodiment; and

FIG. 7 is a configuration diagram of the SNPN-RAN entity according to each example embodiment.

### EXAMPLE EMBODIMENT

### First Example Embodiment

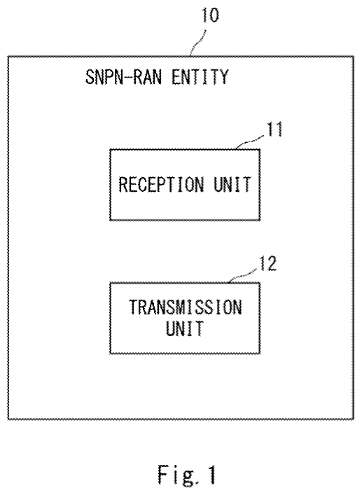

Example embodiments of the present disclosure will be described below with reference to the drawings. A configuration example of an SNPN-Radio Access Network (RAN) entity (hereinafter referred to as an SNPN-RAN) 10 according to a first example embodiment will be described by using FIG. 1. The SNPN-RAN 10 may be a computer device that operates by causing a processor to execute a program stored in a memory. The SNPN-RAN 10 includes a reception unit 11 and a transmission unit 12. The components that compose the SNPN-RAN 10, such as the reception unit 11 and the transmitter 12, may be software or modules in which processing is executed by causing a processor to execute a program stored in a memory. Alternatively, the components that compose the SNPN-RAN 10 may be hardware such as circuits or chips.

The SNPN-RAN 10 may be a base station supporting 5G, the specification of which is defined in 3GPP as a radio communication system. For example, the SNPN-RAN 10 may be a gNB (a gNode B).

The reception unit 11 receives, from a base station deployed in a network operated by a communication carrier, emergency information transmitted by using a frequency used by the communication carrier. The network operated by the communication carrier may be referred to as a mobile network operator (MNO) network, a public land mobile network (PLMN), or the like.

The base station deployed in the network operated by the communication carrier may be, for example, a base station supporting 5G, the specification of which is defined in 3rd Generation Partnership Project (3GPP) as a radio communication system. The base station deployed in the network operated by the communication carrier may be, for example, a gNB (a gNode B). In the following description, the frequency used by the communication carrier is described using the term “carrier frequency”.

The emergency information includes a commercial mobile alert system (CMAS), an earthquake and tsunami warning system (ETWS), a Korean public alert system (KPAS), and information distributed in EU-ALERT, which are defined in Non Patent Literature 3.

The transmission unit 12 transmits, by using a frequency used in a Stand-Alone Non-Public Network (SNPN), the emergency information to a communication terminal registered in the SNPN. In the following description, the frequency used in the SNPN is described using the term “local frequency”. The transmission unit 12 transmits the emergency information to a communication terminal that belongs to an area where communication can be performed by using the local frequency.

As described above, the SNPN-RAN 10 transmits emergency information received from a base station deployed in a network operated by a communication carrier to a communication terminal that belongs to an area where communication can be performed by using a local frequency. By doing so, a communication terminal capable of performing communication using only the local frequency can receive emergency information transmitted in the network operated by the communication carrier.

### Second Example Embodiment

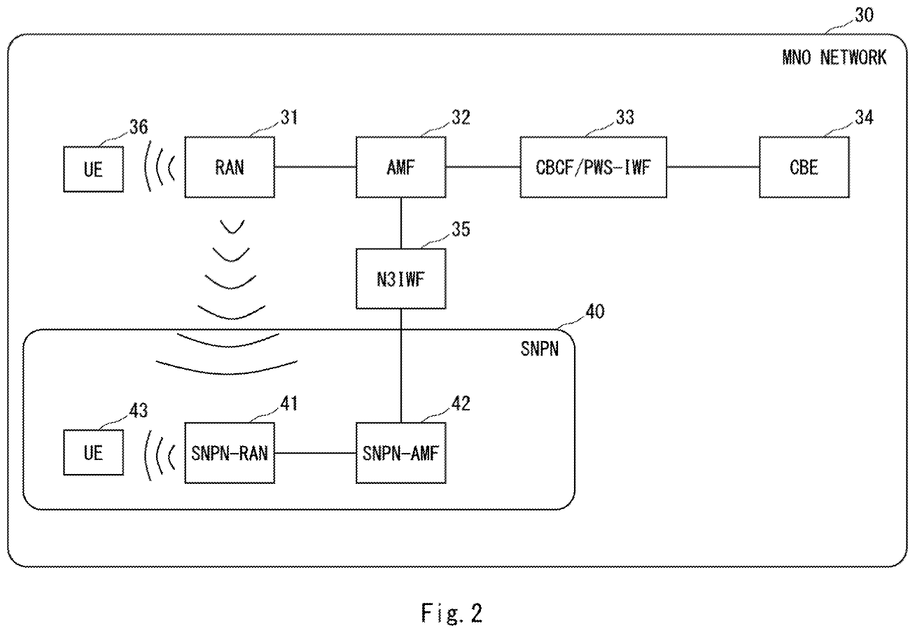

Next, a configuration example of a communication system according to a second example embodiment will be described by using FIG. 2. The communication system in FIG. 2 illustrates a configuration in which an MNO network 30 includes a SNPN 40. That is, the SNPN 40 overlaps with some areas of the MNO network 30. In other words, the MNO network 30 includes the SNPN 40. Alternatively, some areas of the SNPN 40, rather than the entire areas of the SNPN 40, may overlap with some areas of the MNO network 30. The some areas of the SNPN 40 overlapping the areas of the MNO network 30 may be, for example, areas formed by an SNPN-RAN 41 included in the SNPN 40 to perform radio communication.

The MNO network 30 includes a radio access network (RAN) entity (hereinafter, referred to as RAN) 31, an access and mobility function (AMF) entity (hereinafter, referred to as AMF) 32, a cell broadcast centre function (CBCF)/public warning system-interworking function (PWS-IWF) entity (hereinafter, referred to as CBCF/PWS-IWF) 33, a cell broadcast entity (CBE) 34, and a non-3GPP interworking function (N3IWF) entity (hereinafter, referred to as N3IWF) 35. A user equipment (UE) 36 is a communication terminal held by a user who uses the MNO network 30.

The RAN 31 is, for example, a base station supporting 5G as a radio system, and may be, for example, a gNB. The AMF 32 manages access and mobility related to the UE 36 held by a user using the MNO network 30. Specifically, the AMF 32 manages location information of the UE 36, and executes an authentication process of the UE 36 in cooperation with an authentication device (not illustrated).

The CBE 34 may be, for example, a server device and the like managed by an administrative agency that monitors an earthquake, a tsunami, or the like. The CBE 34 generates emergency information and transmits the generated emergency information to the CBCF/PWS-IWF 33. The CBCF/PWS-IWF 33 is a device in which a CBCF entity and a PWS-IWF entity are integrated together. When receiving the emergency information from the CBE 34, the CBCF/PWS-IWF 33 specifies a distribution area of the emergency information. For example, the CBCF/PWS-IWF 33 specifies a cell, a tracking area (TA), or an emergency area (EA) as a distribution area. The EA is a distribution area that can be uniquely set by a communication carrier regardless of the TA.

The N3IWF 35 communicates with a UE 43 via the SNPN 40. The N3IWF 35 connects between different networks each other, and relays control data that is related to the UE 43 and is transmitted between the UE 43 and the AMF 32. The control data may be referred to as control (C)-Plane data. The emergency information may be transmitted as C-Plane data.

The SNPN 40 includes the SNPN-RAN entity (hereinafter referred to as the SNPN-RAN) 41 and an SNPN-AMF entity (hereinafter referred to as an SNPN-AMF) 42. The SNPN-RAN 41 may be a base station deployed in the SNPN. For example, the SNPN-RAN 41 may be a gNB supporting 5G as a radio system. The SNPN-RAN 41 receives information transmitted from the RAN 31. Specifically, like the UE 36 located in a communication area formed by the RAN 31, the SNPN-RAN 41 receives information. The communication area formed by the RAN 31 is an area in which the RAN 31 communicates with a communication terminal or the like by using a carrier frequency. That is, the SNPN-RAN 41 performs a reception operation similar to that performed by the UE 36 when the SNPN-RAN 41 communicates with the RAN 31, and operates as a gNB when it communicates with the UE 43.

The SNPN-AMF 42 is equivalent to a SNPN core network device. The SNPN-AMF 42 manages access and mobility related to the UE 43 held by a user using the SNPN 40. Specifically, the SNPN-AMF 42 manages location information of the UE 43, and executes the authentication process of the UE 43 in cooperation with an authentication device (not illustrated). The UE 43 can only perform communication via the SNPN-RAN 41 and the SNPN-AMF 42 when it is managed by the SNPN-AMF 42. That is, the UE 43 cannot perform communication via the RAN 31 when it is managed by the SNPN-AMF 42.

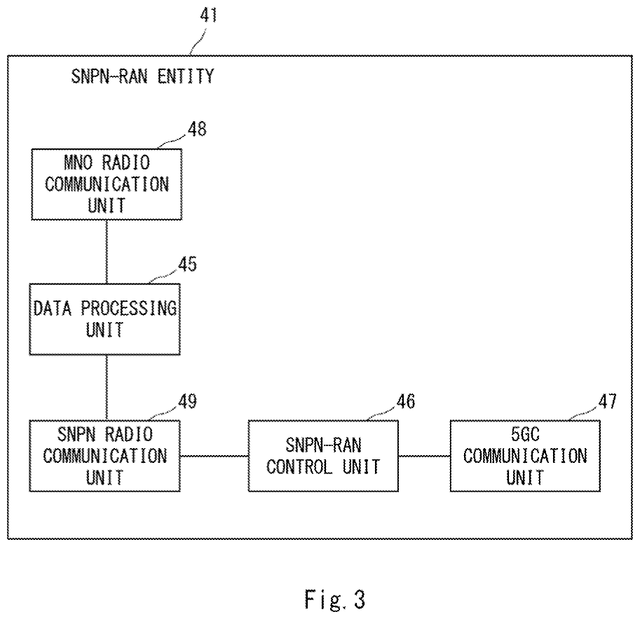

Next, a configuration example of the SNPN-RAN 41 according to the second example embodiment will be described with reference to FIG. 3. The SNPN-RAN 41 includes an MNO radio communication unit 48, a data processing unit 45, an SNPN radio communication unit 49, an SNPN-RAN control unit 46, and a 5GC communication unit 47. The MNO radio communication unit 48 corresponds to the reception unit 11 shown in FIG. 1, and the SNPN radio communication unit 49 corresponds to the transmission unit 12 shown in FIG. 1.

The MNO radio communication unit 48 receives information transmitted from the RAN 31. Like the UE 36 etc., the MNO radio communication unit 48 includes an antenna capable of receiving a signal having the carrier frequency used in the RAN 31 and a demodulation unit that demodulates received information. The MNO radio communication unit 48 receives System Information Block (SIB) information transmitted from the RAN 31. The SIB information includes emergency information. For example, the emergency information is included in SIB6, SIB7, or the like specified in 3GPP. For example, SIB6 contains an ETWS primary notification, and SIB7 contains an ETWS secondary notification. The MNO radio communication unit 48 outputs the received SIB information to the data processing unit 45.

Note that, when the MNO radio communication unit 48 receives SIB information from the RAN 31, the SNPN-RAN 41 may be registered in the AMF 32 like in the case of the UE 36. That is, the SNPN-RAN 41 may be in a state in which a Registration procedure with the AMF 32 is successfully completed. In this case, like the UE 36 registered in the AMF 32, the SNPN-RAN 41 can perform communication in the MNO network 30 by using the carrier frequency.

Alternatively, when the MNO radio communication unit 48 receives SIB information from the RAN 31, the SNPN-RAN 41 may not be registered in the AMF 32. That is, the SNPN-RAN 41 may be in a state in which the Registration procedure with the AMF 32 is not executed or a state in which it is not successfully completed. A state in which the SNPN-RAN 41 is not registered in the AMF 32 as described above is referred to as a limited service state. In the MNO network 30, a communication terminal can receive emergency information such as ETWS even in a limited service state. In other words, a communication terminal in a limited service state can only receive emergency information and cannot perform other communication. Regarding a procedure by which a communication terminal in a limited service state receives emergency information such as ETWS, a generally known procedure specified in 3GPP may be used, and thus a detailed description thereof will be omitted.

The data processing unit 45 extracts emergency information included in SIB information. In other words, the data processing unit 45 extracts parameters indicating emergency information included in SIB information. Further, the data processing unit 45 includes the extracted emergency information in information, a message, or the like to be transmitted to the UE 43 located in a communication area formed by the SNPN-RAN 41. For example, the data processing unit 45 may set the emergency information in SIB information to be transmitted to the UE 43. Alternatively, the data processing unit 45 may include the emergency information in information to be broadcast to the UE 43 located in a communication area formed by the SNPN-RAN 41. The SIB information transmitted to the UE 43 may be similar to SIB information used in the MNO network 30. That is, the UE 43 may set the emergency information in SIB 6 or SIB 7.

The SNPN-RAN control unit 46 performs resource control, scheduling, or the like related to the UE 43 that communicates with the SNPN radio communication unit 49. The 5GC communication unit 47 communicates with the SNPN-AMF 42.

The SNPN radio communication unit 49 transmits emergency information to the UE 43. The SNPN radio communication unit 49 may transmit SIB information including emergency information to the UE 43. The SNPN radio communication unit 49 includes an antenna capable of transmitting a signal having a local frequency and a modulation unit that generates a signal having a local frequency.

Although it is shown in FIG. 3 that the MNO radio communication unit 48 is included in the SNPN-RAN 41, the MNO radio communication unit 48 may instead be installed at a position physically distant from the SNPN-RAN 41. In this case, an apparatus including the MNO radio communication unit 48 may communicate with the SNPN-RAN 41 via a network, for example, through a cable. In this case, it is necessary for the apparatus including the MNO radio communication unit 48 to be installed in a communication area formed by the RAN 31. On the other hand, the SNPN-RAN 41 may not be installed in the communication area formed by the RAN 31.

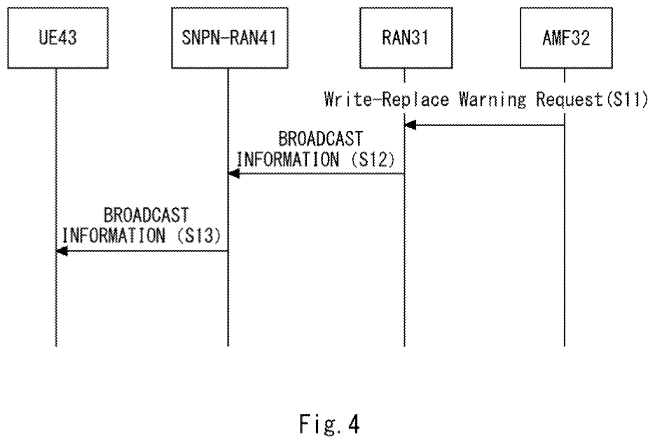

Next, a flow of processes for transmitting emergency information according to the second example embodiment will be described with reference to FIG. 4. First, the AMF 32 transmits a Write-Replace Warning Request message to the RAN 31 (S11). The AMF 32 receives the Write-Replace Warning Request message from the CBE 34 via the CBCF/PWS-IWF 33. The Write-Replace Warning Request message received by the AMF 32 includes emergency information and a distribution area of the emergency information. The AMF 32 transmits the Write-Replace Warning Request message including the emergency information to the RAN 31 included in the distribution area included in the received Write-Replace Warning Request message. The AMF 32 may transmit, to the RAN 31, a Write-Replace Warning Request message including information specifying a particular Cell as the distribution area.

The RAN 31 transmits the emergency information to the SNPN-RAN 41 as broadcast information (S12). Although not shown in FIG. 4, the RAN 31 also transmits the broadcast information to a plurality of UEs including the UE 36 located in the communication area of the RAN 31. The RAN 31 may repeatedly transmit the broadcast information to the SNPN-RAN 41. When a distribution area is specified in the received Write-Replace Warning Request message, the RAN 31 transmits the broadcast information to the specified Cell. When a distribution area is not specified in the received Write-Replace Warning Request message, the RAN 31 transmits the broadcast information to all the Cells.

The RAN 31 transmits a Primary Notification and a Secondary Notification to the SNPN-RAN 41 as emergency information. In the Primary Notification, for example, a Warning Type is notified to the UE 43 by the SIB 6 which is the broadcast information. The Warning Type indicates, for example, a disaster type. In the Secondary Notification, for example, a Warning message is notified to the UE 43 by the SIB 7 as the broadcast information. The Warning message indicates, for example, the contents of a message.

The SNPN-RAN 41 transmits the emergency information received from the RAN 31 to the UE 43 as the broadcast information (S13). The SNPN-RAN 41 receives the broadcast information transmitted from the RAN 31 by using a carrier frequency. Further, the SNPN-RAN 41 transmits the broadcast information to the UE 43 by using a local frequency. That is, the SNPN-RAN 41 extracts emergency information from the broadcast information transmitted by using the carrier frequency, and transmits the extracted emergency information to the UE 43 by using the local frequency. Further, the SNPN-RAN 41 may edit the contents of the emergency information to be transmitted to the UE 43 based on the emergency information received from the RAN 31, and transmit the edited emergency information to the UE 43 by using the local frequency. For example, when the SNPN 40 is set in the factory, the edited emergency information of the SNPN-RAN 41 may be data that can be understood by various types of machines connected to the UE 43 and may, more particularly, be operation instructions for these various types of machines.

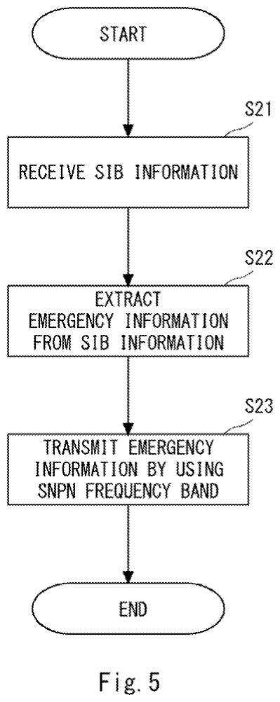

Next, a flow of processes for transmitting emergency information in the SNPN-RAN 41 according to the second example embodiment will be described with reference to FIG. 5. First, the MNO radio communication unit 48 of the SNPN-RAN 41 receives SIB information (S21). The MNO radio communication unit 48 receives SIB information including the Primary Notification or SIB information including the Secondary Notification. The SIB information is transmitted by using a carrier frequency. The MNO radio communication unit 48 demodulates a signal transmitted by using the carrier frequency, and outputs SIB information obtained by the demodulation of the signal to the data processing unit 45. The MNO radio communication unit 48 of the SNPN-RAN 41 may receive SIB information that has been broadcast by using LTE. For example, when the SNPN using 5G is constructed in an area where a 4G service is provided by the MNO but a 5G service is not yet provided, the MNO radio communication unit 48 receives SIB information of 4G.

Next, the data processing unit 45 extracts emergency information included in the SIB information (S22). For example, the data processing unit 45 may extract a Warning Type when it receives the SIB information including the Primary Notification. Alternatively, when the data processing unit 45 receives the SIB information including the Secondary Notification, it may extract a Warning message.

Next, the SNPN radio communication unit 49 modulates the emergency information extracted by the data processing unit 45, and transmits the emergency information to the UE 43 by using a local frequency (S23). The SNPN radio communication unit 49 may use a radio frequency of 5G or a radio frequency of 4G as the local frequency.

As described above, the SNPN-AMF 42 according to the second example embodiment, like the UE 36, receives broadcast information distributed from the RAN 31. Further, the SNPN-AMF 42 transmits the emergency information included in the received broadcast information to the UE 43 by using the local frequency. By doing the above, the UE 43 can receive the emergency information distributed in the MNO 30 via the SNPN-RAN 41 even when the UE 43 cannot communicate with the RAN 31 since it is registered in the SNPN-AMF 42.

### Third Example Embodiment

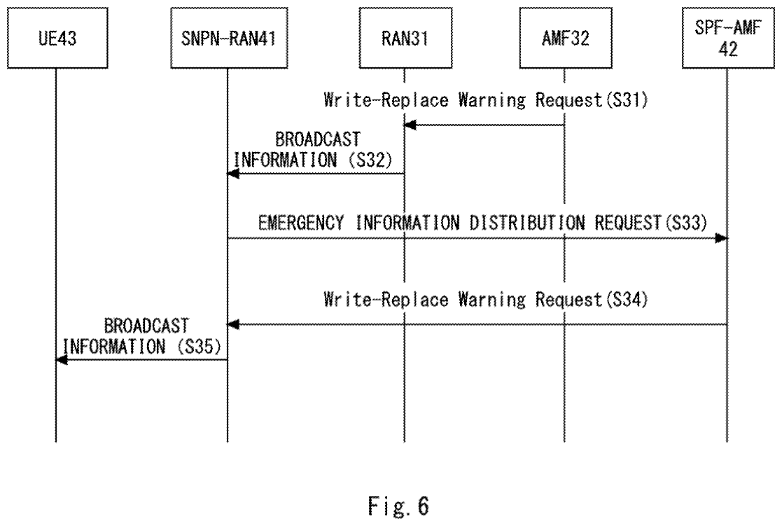

Next, a flow of processes for transmitting emergency information according to a third example embodiment will be described with reference to FIG. 6. Steps S31 and S32 are similar to Steps S11 and S12 shown in FIG. 4, respectively, and thus descriptions thereof will be omitted.

When the SNPN-RAN 41 receives emergency information in Step S32, it transmits an emergency information distribution request message to the SNPN-AMF 42 (S33). The emergency information distribution request message includes the emergency information.

Next, the SNPN-RAN 41 determines a distribution area of the emergency information and transmits a Write-Replace Warning Request message to the SNPN-RAN 41 deployed in the distribution area (S34). FIG. 6 shows that the SNPN-AMF 42 transmits the Write-Replace Warning Request message only to the SNPN-RAN 41. However, when a plurality of SNPN-RAN entities are deployed in the SNPN 40, the SNPN-AMF 42 may transmit the Write-Replace Warning Request messages to two or more SNPN-RAN entities. For example, the SNPN-AMF 42 may transmit the Write-Replace Warning Request messages to SNPN-RAN entities deployed in an area around the SNPN-RAN 41 that has transmitted an emergency information distribution request message. The area around the SNPN-RAN 41 may be defined as being an area within an R (R is a real number greater than or equal to zero) kilometer radius of the SNPN-RAN 41, or may be defined based on an address, such as the same town, ward, city, prefecture, or the like as that of the SNPN-RAN 41.

Alternatively, the SNPN-AMF 42 may transmit the Write-Replace Warning Request messages to all the SNPN-RANs 41 in the SNPN 40.

Next, like in the case of Step S13 shown in FIG. 4, the SNPN-RAN 41 transmits the emergency information included in the Write-Replace Warning Request to the UE 43 as broadcast information (S35). The UE 43 transmits the broadcast information to the UE 43 by using a local frequency.

As described above, in the processes for transmitting emergency information according to the third example embodiment, the SNPN-RAN 41 receives emergency information and then a plurality of SNPN-RANs in the SNPN 40 transmit the emergency information to the UE via the SNPN-AMF 42. The SNPN-RAN 41 transmits an emergency information distribution request message to the RAN 31, whereby even an SNPN-RAN entity which is deployed in the SNPN 40 and is deployed outside the MNO network 30 can receive emergency information that is transmitted through the MNO network 30.

Further, when the SNPN-RAN 41 receives the emergency information in Step S32, it may transmit the emergency information to the UE 43 like in the case of the second example embodiment. That is, when the SNPN-RAN 41 receives emergency information from the RAN 31, it may transmit the emergency information to the UE 43 and also transmit an emergency information distribution request message to the SNPN-AMF 42.

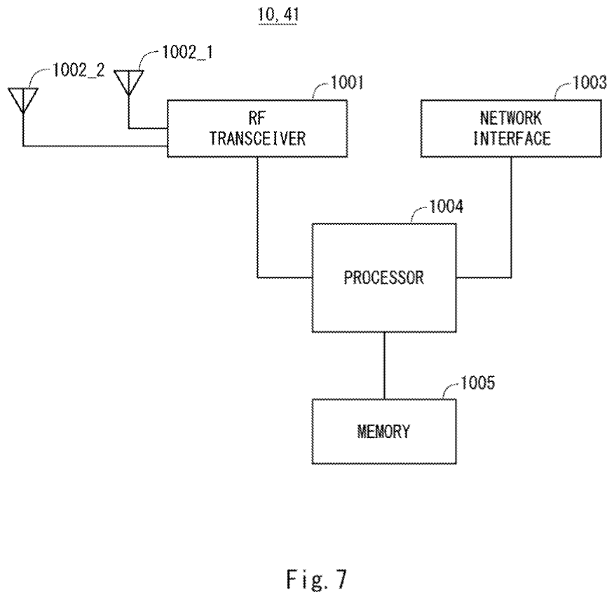

Next, a description will be given of a configuration example of the SNPN-RAN entity 10 and the SNPN-RAN entity 41 (hereinafter collectively referred to as the SNPN-RAN entity 10 and the like) described in the above example embodiments. FIG. 7 is a block diagram showing a configuration example of the SNPN-RAN entity 10 and the like. As shown in FIG. 7, the SNPN-RAN entity 10 and the like include an RF transceiver 1001, a network interface 1003, a processor 1004, and a memory 1005. The RF transceiver 1001 performs analog RF signal processing to communicate with UEs or RAN entities. The RF transceiver 1001 may include a plurality of transceivers. The RF transceiver 1001 is coupled to an antenna 1002_1, an antenna 1002_2, and a processor 1004. The antenna 1002_1 may be used to communicate with the UEs, and the antenna 1002_2 may be used to communicate with the RAN entities. The RF transceiver 1001 receives modulated symbol data (or OFDM symbol data) from the processor 1004, generates a transmission RF signal, and supplies the generated transmission RF signal to the antennas 1002_1 and 1002_2. Further, the RF transceiver 1001 generates a baseband reception signal based on a reception RF signal received by the antennas 1002_1 and 1002_2, and supplies the generated signal to the processor 1004.

The network interface 1003 is used for communicating with a network node (e.g., other core network nodes). The network interface 1003 may include, for example, a network interface card (NIC) compliant with IEEE 802.3 series.

The processor 1004 performs data plane processing and control plane processing including digital baseband signal processing for radio communication. For example, in the case of LTE and 5G, digital baseband signal processing performed by the processor 1004 may include signal processing of a MAC layer and a PHY layer.

The processor 1004 may include a plurality of processors. For example, the processor 1004 may include a modem processor (e.g., a DSP) that performs the digital baseband signal processing and a protocol stack processor (e.g., a CPU or an MPU) that performs the control plane processing.

The memory 1005 is constituted of a combination of a volatile memory and a non-volatile memory. The memory 1005 may include a plurality of memory devices that are physically independent from each other. The volatile memory is, for example, a Static Random Access Memory (SRAM), a Dynamic RAM (DRAM), or any combination thereof. The non-volatile memory is a Mask Read Only Memory (MROM), an Electrically Erasable Programmable ROM (EEPROM), a flash memory, a hard disk drive, or any combination thereof. The memory 1005 may include a storage located away from the processor 1004. In this case, the processor 1004 may access the memory 1005 via the network interface 1003 or a not-illustrated I/O interface.

The memory 1005 may store software modules (computer programs) including instructions and data to perform the processing by the SNPN-RAN entity 10 and the like described in the above example embodiments. In some implementations, the processor 1004 may load the software modules from the memory 1005 and execute the loaded software modules, thereby performing the processing of the SNPN-RAN entity 10 and the like described in the above example embodiments.

It should be noted that the present disclosure is not limited to the above-mentioned example embodiments, and can be modified as appropriate within a range not deviating from the gist.

Some or all of the above example embodiments may also be described as the following supplementary notes, but are not limited to the following.

(Supplementary Note 1)

An SNPN-RAN entity comprising:

a reception unit configured to receive, from a base station deployed in a network operated by a communication carrier, emergency information transmitted by using a first frequency used by the communication carrier; and

a transmission unit configured to transmit, by using a second frequency used in a Stand-Alone Non-Public Network (SNPN), the emergency information to a communication terminal registered in the SNPN.

(Supplementary Note 2)

The SNPN-RAN entity according to Supplementary note 1, wherein the reception unit is configured to receive the emergency information included in first SIB information transmitted in the network operated by the communication carrier.

(Supplementary Note 3)

The SNPN-RAN entity according to Supplementary note 2, further comprising a data processing unit configured to extract the emergency information included in the first SIB information and set the emergency information in second SIB information to be transmitted by using the second frequency,

wherein the transmission unit is configured to transmit the second SIB information including the emergency information to the communication terminal registered in the SNPN by using the second frequency.

(Supplementary Note 4)

The SNPN-RAN entity according to any one of Supplementary notes 1 to 3, wherein the reception unit is configured to receive, as a communication terminal in a limited service state in which it is possible to receive the emergency information transmitted from the base station, the emergency information transmitted from the base station even when the SNPN-RAN entity is not registered in the network operated by the communication carrier.

(Supplementary Note 5)

The SNPN-RAN entity according to any one of Supplementary notes 1 to 4, wherein the reception unit is configured to receive the emergency information transmitted from the base station as a communication terminal capable of performing communication in the network operated by the communication carrier in a state in which the SNPN-RAN entity is registered in the network operated by the communication carrier.

(Supplementary Note 6)

The SNPN-RAN entity according to any one of Supplementary notes 1 to 5, wherein the transmission unit is configured to transmit the emergency information to an SNPN core network apparatus deployed in the SNPN, and transmit the emergency information to the communication terminal registered in the SNPN by using the second frequency based on a distribution instruction message of the emergency information received from the SNPN core network apparatus.

(Supplementary Note 7)

A distribution system comprising:

a reception apparatus configured to receive, from a base station deployed in a network operated by a communication carrier, emergency information transmitted by using a first frequency used by the communication carrier; and

an SNPN-RAN entity configured to transmit, by using a second frequency used in a Stand-Alone Non-Public Network (SNPN), the emergency information received from the reception apparatus to a communication terminal registered in the SNPN.

(Supplementary Note 8)

The distribution system according to Supplementary note 7, wherein the reception apparatus is configured to receive the emergency information included in first SIB information transmitted in the network operated by the communication carrier.

(Supplementary Note 9)

The distribution system according to Supplementary note 8, wherein the SNPN-RAN entity is configured to extract the emergency information included in the first SIB information, set the emergency information in second SIB information to be transmitted by using the second frequency, and transmit the second SIB information including the emergency information to the communication terminal registered in the SNPN by using the second frequency.

(Supplementary Note 10)

A distribution method comprising:

receiving, from a base station deployed in a network operated by a communication carrier, emergency information transmitted by using a first frequency used by the communication carrier; and

transmitting, by using a second frequency used in a Stand-Alone Non-Public Network (SNPN), the emergency information to a communication terminal registered in the SNPN.

(Supplementary Note 11)

A program for causing a computer to:

receive, from a base station deployed in a network operated by a communication carrier, emergency information transmitted by using a first frequency used by the communication carrier; and

transmit, by using a second frequency used in a Stand-Alone Non-Public Network (SNPN), the emergency information to a communication terminal registered in the SNPN.

Although the present disclosure has been described with reference to the example embodiments, the present disclosure is not limited to the above-described example embodiments. Various changes that may be understood by those skilled in the art may be made to the configurations and details of the present disclosure within the scope of the disclosure.

This application is based upon and claims the benefit of priority from Japanese patent application No. 2020-76125, filed on Apr. 22, 2020, the disclosure of which is incorporated herein in its entirety by reference.

### REFERENCE SIGNS LIST

10 SNPN-RAN ENTITY
11 RECEPTION UNIT
12 TRANSMISSION UNIT
30 MNO NETWORK
31 RAN
32 AMF
33 CBCF/PWS-IWF
34 CBE
35 N3IWF
36 UE
40 SNPN
41 SNPN-RAN
42 SNPN-AMF
43 UE
45 DATA PROCESSING UNIT
46 SNPN-RAN CONTROL UNIT
47 5GC COMMUNICATION UNIT
48 MNO RADIO COMMUNICATION UNIT
49 SNPN RADIO COMMUNICATION UNIT

What is claimed is:

1. An SNPN-RAN entity comprising:
at least one memory storing instructions, and
at least one processor configured to execute the instructions to;
receive, from a base station deployed in a network operated by a communication carrier, emergency information transmitted by using a first frequency used by the communication carrier; and
transmit, by using a second frequency used in a Stand-Alone Non-Public Network (SNPN), the emergency information to a communication terminal registered in the SNPN.

2. The SNPN-RAN entity according to claim 1, wherein the at least one processor is further configured to execute the instructions to receive the emergency information included in first SIB information transmitted in the network operated by the communication carrier.

3. The SNPN-RAN entity according to claim 2, wherein the at least one processor is further configured to execute the instructions to extract the emergency information included in the first SIB information and setting the emergency information in second SIB information to be transmitted by using the second frequency, and
transmit the second SIB information including the emergency information to the communication terminal registered in the SNPN by using the second frequency.

4. The SNPN-RAN entity according to claim 1, wherein the at least one processor is further configured to execute the instructions to receive, as a communication terminal in a limited service state in which it is possible to receive the emergency information transmitted from the base station, the emergency information transmitted from the base station even when the SNPN-RAN entity is not registered in the network operated by the communication carrier.

5. The SNPN-RAN entity according to claim 1, wherein the at least one processor is further configured to execute the instructions to receive the emergency information transmitted from the base station as a communication terminal capable of performing communication in the network operated by the communication carrier in a state in which the SNPN-RAN entity is registered in the network operated by the communication carrier.

6. The SNPN-RAN entity according to claim 1, wherein the at least one processor is further configured to execute the instructions to transmit the emergency information to an SNPN core network apparatus deployed in the SNPN, and transmit the emergency information to the communication terminal registered in the SNPN by using the second frequency based on a distribution instruction message of the emergency information received from the SNPN core network apparatus.

7.-9. (canceled)

10. A distribution method comprising:
receiving, from a base station deployed in a network operated by a communication carrier, emergency information transmitted by using a first frequency used by the communication carrier; and
transmitting, by using a second frequency used in a Stand-Alone Non-Public Network (SNPN), the emergency information to a communication terminal registered in the SNPN.

11. A non-transitory computer readable medium storing a program for causing a computer to:
receive, from a base station deployed in a network operated by a communication carrier, emergency information transmitted by using a first frequency used by the communication carrier; and
transmit, by using a second frequency used in a Stand-Alone Non-Public Network (SNPN), the emergency information to a communication terminal registered in the SNPN.
